(19) United States
(12) Patent Application Publication
(10) Pub. No.: US 2002/0030070 A1
(43) Pub. Date: Mar. 14, 2002

(54) Method and apparatus for treatment of metal cascades in flame and gas

(76) Inventor: John R. Hugens JR., Suwanee, GA (US)

Correspondence Address: NEEDLE & ROSENBERG, P.C., The Candler Building, Suite 1200, 127 Peachtree Street, N.E., Atlanta, GA, 30303-1811, US

(21) Appl. No.: 09/873,121

(22) Filed: May 31, 2001

Related U.S. Application Data
(60) Provisional application No. 60/208,620, filed on Jun. 1, 2000.

(51) Int. Cl. C21B 13/00; C21C 7/00; B22D 45/00; B67D 5/00

(52) U.S. Cl. 222/590; 222/603; 266/217; 266/44

(57) ABSTRACT

A method of adding gasses to, and removing gasses from a molten metal is disclosed. A molten metal is passed from a metal making furnace and cascaded through a gas or a flame. The flame is generated by a combustion burner and has an inner core of a first gas and an outer core of a second gas which jackets the first gas. As the metal is cascaded through the flame or gas, the first gas is passed into the molten metal. In the alternative, the cascade of molten metal may be passed through the first gas, or the first gas may be mixed with molten metal. The first gas may be used to sparge, react with, degassify, or otherwise dissolve within the molten metal. The device of the invention comprises a vessel for receiving the molten metal, a transfer trough extending from the furnace toward the vessel, and a combustion burner positioned with respect to the transfer trough and the vessel. The combustion burner is adapted to emit a flame or gas flow therefrom, and the transfer trough is adapted to pass the molten metal into the flame or gas flow, or to permit the flame or gas flow to pass through the molten metal as the metal enters the vessel. The device also includes a combustion burner constructed and arranged to cascade the molten metal as it is passed over a stair-step burner face provided as a part of the burner.

### CROSS REFERENCE TO RELATED APPLICATIONS

This patent application claims priority to U.S. provisional Patent Application No. 60/208,620 filed on Jun. 1, 2000, in the United States Patent and Trademark Office.

### FIELD OF THE INVENTIONS

The invention relates in general to methods and devices used to add gasses to, or remove gasses from molten metals. More particularly, the invention relates to methods and devices used to add a gas to a molten metal cascaded through a flame or a gas.

### BACKGROUND OF THE INVENTION

It is known is the course of processing molten metals to treat the metals with a gas. For example, it is customary to introduce gases such as nitrogen and argon into molten aluminum and molten aluminum alloys in order to remove undesirable constituents such as hydrogen gas, non-metallic inclusions, and alkali materials. Similarly, it is known to pass carbon monoxide, carbon dioxide, or nitrogen into molten copper for the purpose of removing dissolved hydrogen therefrom, or to pass oxygen into the molten copper for the purpose of oxygenating the copper and to improve the metallographic uniformity thereof.

As known, gases have been mixed with molten metals by injection through stationary members such as lances, or through porous diffusers. These techniques suffer from the drawback that inadequate dispersion of the gas throughout the molten metal can occur. In the effort to improve the dispersion of the gas within the molten metal, it is known to stir the molten metal, or otherwise convey the metal past a source of gas injection. Devices also are known that accomplish both of these functions, i.e. those that will both stir the molten metal while simultaneously injecting a gas into the metal, for example within a metal bath.

In devices which stir or otherwise directly inject a gas into a metal bath, the problem arises that cavitation can occur, or a vortex is developed that will move inside of the vessel but fails to thoroughly mix the gas within the molten metal or metal bath. Also, the known types of devices tend to dispense gas bubbles that are too large, or which are not otherwise uniformly distributed throughout the molten metal. An additional problem that results from the known types of devices, particularly those which are passed directly into the molten metal or metal bath, is that the metal can act to plug or clog the gas outlet ports of the device. Additionally, these devices are used in a relatively severe environment, and are susceptible to oxidation, erosion, or degradation over time.

What is needed, therefore, but seemingly unavailable in the art, is an improved device and method of adding a gas to, and/or removing a gas from, a molten metal that will overcome the problems encountered with the known types of devices, which will provide a prolonged service life, and which is adapted for use within a severe operating environment. Moreover, there is a need for such an improved method and device which can be used with any desired type of molten metal, and can be used to pass any desired type of gas, gas flow, or flame, in any desired composition, into the molten metal, or through which the molten metal may be passed. There is a need also for a device and a method for use thereof that will more efficiently pass a gas into a molten metal, or which can be used to pass a molten metal through a gas for the purposes of using the gas to sparge the molten metal, to react with the molten metal, to mix with the molten metal, or to diffuse within the molten metal, as desired.

### SUMMARY OF THE INVENTION

The present invention provides an improved method of adding gasses to, and/or removing gasses from a molten metal that overcome some of the design deficiencies of the known methods and devices of the art. Accordingly, and in a first embodiment, a method of the invention includes the steps of passing a molten metal from a metal making furnace and cascading the molten metal through a gas flow or a flame comprised of an inner core of a first gas and an outer core of a second gas which jackets the first gas. While cascading the molten metal through the flame or gas flow, the first gas is passed into the molten metal.

In the alternative, the cascade of molten metal may be passed through the first gas, or the first gas may be mixed with the molten metal. The first gas may thus be used to sparge, react with, or dissolve within the molten metal in both the cascade of metal, as well as in a metal bath, for example, into which the cascade of molten metal flows or collects.

The method also includes the step of the molten metal carrying the first gas into the metal bath, whereupon the first gas is used to degas, sparge, react with, or dissolve within the metal bath. The steps of controlling the temperature of the metal bath with the flame, injecting the gas into the molten metal cascade along an axis of the burner, and of the first gas atomizing the cascade of molten metal as the gas/gas flow is passed into the molten metal are also a part of the invention. Additionally, the cascade of molten metal may be dispersed by the gas or flame and carried thereby into or toward the downstream device.

In the inventive method, the molten metal may be cascaded into the gas flow or flame from therebeneath, from thereabove, or the combustion burner may be adapted to cascade the molten metal as it is passed over the burner.

Accordingly, in an alternate embodiment of the invention, the method includes the steps of collecting the molten metal and passing the molten metal over a burner emitting a gas flow or a flame such that it cascades the molten metal while also passing a gas into the molten metal. This method includes the steps of passing the molten metal over a burner emitting a two part flame comprised of an inner core of a first gas, and an outer core of a second gas jacketing the first gas. The flame cascades the molten metal as it is passed over the burner, and simultaneously passes the first gas into the molten metal.

A preferred embodiment of the inventive device comprises a vessel adapted to receive the molten metal therein, and a transfer trough, for example a launder, a pipe, a trough, or any other suitable means adapted for the transport of a molten metal, which extends from the furnace toward the vessel. The device includes a combustion burner positioned with respect to the transfer trough and facing into the vessel for passing a gas flow or flame therefrom. The transfer trough is situated such that it will pass or direct the molten metal therefrom and into the gas flow or flame, or will otherwise permit the gas flow or flame to pass through the molten metal as the metal falls from the trough and enters the vessel. The transfer trough may be constructed to pass the molten metal into the flame or gas flow from therebeneath, or from thereabove. The flame and gas flow may also be used to disperse the molten metal within the vessel.

In another embodiment of the device of the invention, a transfer trough is extended toward a downstream device and a combustion burner having a stair-step shaped burner face constructed and arranged to emit a gas flow therethrough is positioned with respect to the transfer trough such that the stair-step burner face extends into the transfer trough. The transfer trough is constructed and arranged to pass the molten metal over the burner face so that a gas flow or flame emitted through the burner face cascades the molten metal passed thereover. So constructed, a gas, whether from a gas flow or a flame, is passed into and mixed with the molten metal while it also cascades the molten metal over the burner face.

It is to these objects, as well as the other objects, features, and advantages of the present invention, which will become apparent upon reading the specification, when taken in conjunction with the accompanying drawings, to which the invention is directed.

### BRIEF DESCRIPTION OF THE DRAWINGS

FIG.1 is a schematic illustration of a first embodiment of a device and method of the invention.

FIG. 2 is a schematic illustration of a second embodiment of a device and method of the invention.

FIG. 3 is an illustration of a combustion burner adapted for use with the devices and methods of this invention and having a stair-step shaped burner face over which a molten metal may be cascaded.

FIG. 4 is a schematic illustration of the combustion burner of FIG. 3 within a third embodiment of a device and method of the invention.

### DETAILED DESCRIPTION

Referring now in detail to the drawings, in which like reference characters indicate like parts throughout the several views, a first embodiment of a device 5 for use in adding gas to, or removing gas from, respectively, a molten metal is disclosed. The device 5 includes a vessel 7 conventionally fashioned and constructed, having an oxidation resistant refractory lining 8 provided as a part thereof. Situated within the vessel is a metal bath 9, comprised of the molten metal 13 to which gas will be added or removed by the method and device of the invention. Both of the molten metal, and the metal bath referred to herein may comprise any type of molten ferrous or non-ferrous metallic materials, to include aluminum, copper, iron, and alloys thereof, all of which are amenable to gas purification. Moreover, the term “gas” as used herein is understood to mean any gas or combination of gases, including argon, nitrogen, chlorine, freon, oxygen, and the like that have a purifying effect upon molten metals with which they are mixed, or into which they are otherwise passed. Both the molten metal and metal bath are in a liquid state, as understood by those skilled in the art.

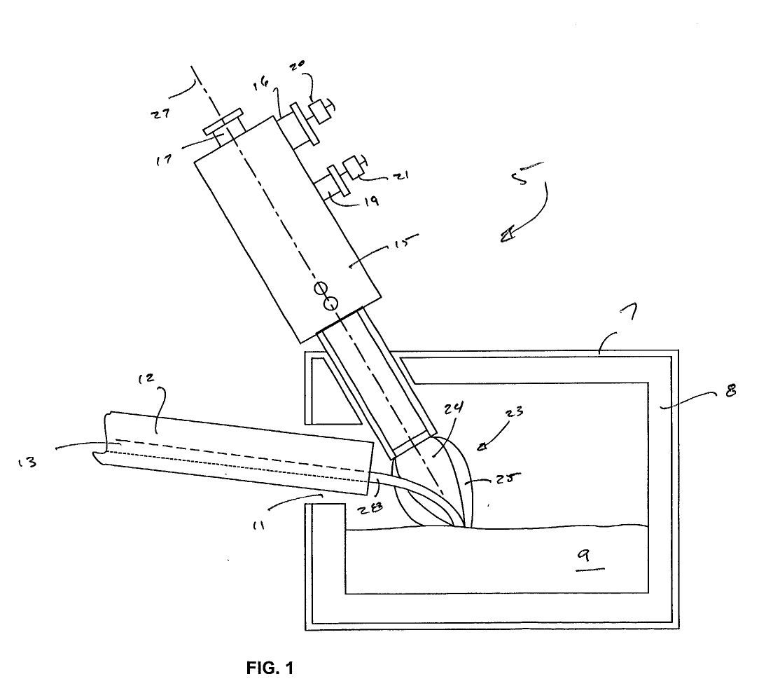

Still referring to FIG. 1, an opening 11 is defined within a side wall of the vessel through which an elongate transfer trough 12 is passed. The transfer trough may be a launder, as that term is understood and known by those skilled in the art, or any other type of transfer pipe, duct, or passageway adapted for transferring a molten metal from a metal making furnace (not illustrated), for example, to a downstream device. Illustrative downstream devices include, for example the vessel 7, a holding furnace (not illustrated), or a continuous caster (not illustrated). The transfer trough 12 is extended into the vessel and positioned above and with respect to the metal bath 9 collected or formed therein. The molten metal is allowed to pass through the transfer trough and fall freely into the metal bath.

A combustion burner 15, of any known and conventional construction, for example those combustion burners manufactured and distributed by American Combustion, Inc., and which may include that combustion burner illustrated in U.S. Pat. No. 4,797,087, the provisions of which are incorporated herein fully by this reference, is provided as a part of the device 5. So constructed, the combustion burner is provided with a fuel port 16, a combustion air port 17, and an oxygen port 19. The fuel port is provided with a separate fuel flow meter 20, and the oxygen port is provided with a separate oxygen flow meter 21, such that the combustion burner, in accordance with known methods of operations, can be accurately controlled in order to more accurately create the desired gas flow and/or flame characteristics or composition passed from the burner.

So constructed, the burner emits a flame 23 comprised of an inner core 24 of a first gas, for example, oxygen, with an outer core 25 of a second gas which fully jackets for otherwise envelops the inner core for keeping the inner core of the gas flow or flame intact, and for otherwise shielding the metal bath held within, and the refractory lining of, the vessel. The flame 23, therefore, is emitted in known fashion, to have the above-described first and second gases, which gases may comprise any desired gases, in any desired combination, for attaining any desired purpose.

Accordingly, and in all of the embodiments of the invention, the inner core or first gas used in the burner flame may include a reactive gas, for example an oxidizing reducing gas, to include carbon monoxide, carbon dioxide, hydrogen, oxygen, water, ozone, air, ozone/air, and oxygen/air mixtures, nitrogen oxides, sulfur oxides, sulfur gas, hydrogen cyanide, ammonia, arsine, stibine, uranium hexafluoride, selenium or tellurium vapor, nickel carbonyl, naphthalene, or paraffin gases such as methane, ethane, propane and butane. The inner core or first gas may also comprise vaporized alcohols, halogens, or metal halogen compounds, vaporized alloying compounds, such as phosphorus, potassium, calcium, sodium, or lithium, and may also include fine suspensions of solid materials, such as metal powders or alloys to include graphite, otherwise suspended in an inert gas. Any desired inert or neutral gas that may be used as a part of the inner core or first gas of the combustion flame may include argon, neon, nitrogen, and helium. The inert gases may predominate in the inner core, and may shield the cascade of metal, as described in greater detail below, within the flame from the atmosphere outside the flame, or act as a sparging agent for the cascade of molten metal.

The outer core or second gas of the combustion flame, again in all of the embodiments of the invention, may comprise a different gas mixture, and, as known, may be used to neutralize, shield, jacket, or otherwise heat the inner core of the flame. The outer core of the flame may thus contain any of the gases or solids specified above. Moreover, if the outer core of the flame is intended to be an oxidizing core or gas, then the inner core can be a neutral or inert gas, and vice versa. Also, and as known, the outer flame core also serves to protect the furnace walls and metal bath from degradation or excess oxidation by shielding them from the inner core/first gas of the combustion flame.

The gas mixture composition of the inner and outer core gases of the combustion flame may be modulated or changed in composition periodically to induce a corresponding change in the composition of the molten metal passing through the flame. Such modulation may be useful in the calibration of process instruments, such as oxygen detectors, or other detectors that will sample the metal cascade which is passed through the flame, or through with the flame is passed. Such instruments may also be used to control the flame and accordingly the molten metal properties.

Still referring to FIG. 1, therefore, a cascade 28 of the molten metal 13 is passed off of the end of the transfer trough 12 extended into the interior of the vessel 7. The flow rate of the molten metal, and in particular the cascade thereof, as well as the construction and orientation of the transfer trough, are such that the cascade of molten metal is passed into the combustion flame, and more particularly into both the inner core, and the outer core thereof. As shown, the combustion flame extends in a longitudinal or axial direction along a burner axis 27, and extends into the metal bath, when, and as desired, for any of the known uses in directing a combustion flame into a molten metal bath.

By passing the cascade 28 of molten metal into the combustion flame, it is anticipated that the inner core or first gas 24 will be used to either sparge the molten metal, to react with the molten metal to obtain a desired metal property, to be dissolved within the molten metal for the purpose of degassing the metal, for example, or the gas may be mixed into the molten metal for changing the properties thereof. For example, if the inner core 24 is comprised of oxygen, then the inner core will be mixed into or otherwise dissolved within the cascade of molten metal, for example copper, for the purpose of oxygenating the copper to improve its machinability, as well as its metallographic uniformity.

So constructed, the device 5, and in particular the combination of the vessel, the transfer trough, and the combustion burner, along with the combustion flame, act to create a variable oxidizing atmosphere through which the cascade of molten metal is passed, as well as controlling the oxygen content of the vessel 7. By utilizing the construction of the device 5 as shown, in association with the method described as a part hereof, it is anticipated that oxygen content in the range of from 0 to 500 ppm with respect to the molten metal may result from the cascading of the molten metal through the combustion flame or gas flow.

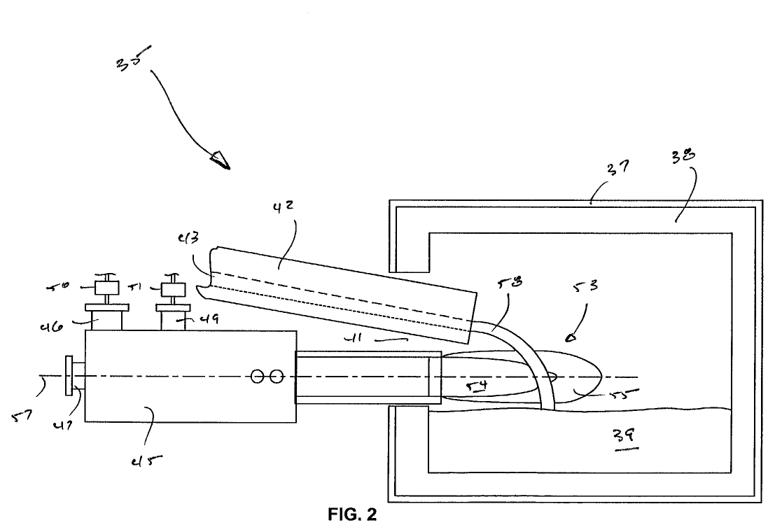

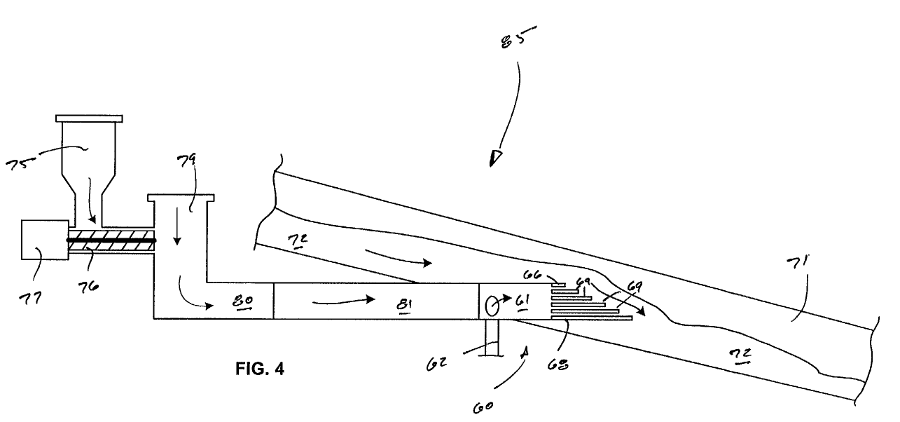

For example if using oxygen with a molten metal which comprises copper, by controlling the amount of oxygen supplied to the combustion burner, the copper producer is therefore able to control the amount of oxygen added to the molten copper. This, of course, holds true with any combination of gases, and molten metals used with the device 5, as well as with the devices 35 and 85 of FIGS. 2 and 4, respectively. Also, by cascading the molten metal through the gas flow or flame, the gas can be used to atomize the molten metal as it is cascaded therethrough, again for varying or altering the physical and/or metallurgical characteristics of the molten metal. The phrases gas flow and flame/combustion flame herein are used interchangeably, in that each involves the passage of a gas, whether combusted or non-combusted, from a burner or a gas injection port or device.

As illustrated, the combustion burner is inclined with respect to and facing toward the metal bath 9. It is thus anticipated that the combustion burner, and in particular the flame 23 thereof, can be used to separately sparge, react with, mix, or dissolve a gas or gases in the metal bath when and as desired. It is also anticipated that the inner core/first gas 24 can be injected into the flame along the burner axis 27 at a high velocity for both mixing the gas within the cascade of molten metal, as well as being used to inject the gas directly and deeply into the metal bath for the purpose of enhancing the mixing of the gas therein.

Referring now to FIG. 2, a second embodiment of a device 35 of the invention is disclosed. The device 35 includes a vessel 37 constructed and arranged to receive a molten metal therein, the vessel having an oxidation resistant refractory lining 38, suitable for housing a metal bath 39 therein. An opening 41 is defined within a side wall of the vessel, through which an elongate transfer trough 42 extends, with a molten metal 43 passed through the transfer trough and into the vessel, becoming a part of and defining the metal bath 39.

A combustion burner 45 is provided, which may again comprise any desired type of combustion burner, and thus may include the combustion burners referenced and described above. The combustion burner has a fuel port 46, a combustion air port 47, and/or an oxygen port 49 provided as a part thereof. A fuel flow meter 50, and an oxygen flow meter 51, are provided respectively, for controlling the operation of the burner as well as for controlling the composition of the gas flows passed therethrough. A combustion flame 53 is emitted from the combustion burner 45, the flame having an inner core of a first gas 54, and a second gas forming an outer core 55 which jackets or envelops the inner core, the combustion flame extending along a burner axis 57.

As shown in FIG. 2, a cascade 58 of the molten metal is passed into the flame from above the flame, such that the flame is passed through the cascade of molten metal. The flame thus acts to sparge, gasify, react with, or mix the first gas within the molten metal in any desired fashion. The flame may also be used to disperse and/or carry the molten metal/gas combination into the vessel and the metal bath therein. In this manner, therefore, the molten metal 43 carries the desired gas into the metal bath as a part of the cascade of molten metal. Also, the gas flow or flame may be used to atomize the cascade of molten metal, if desired.

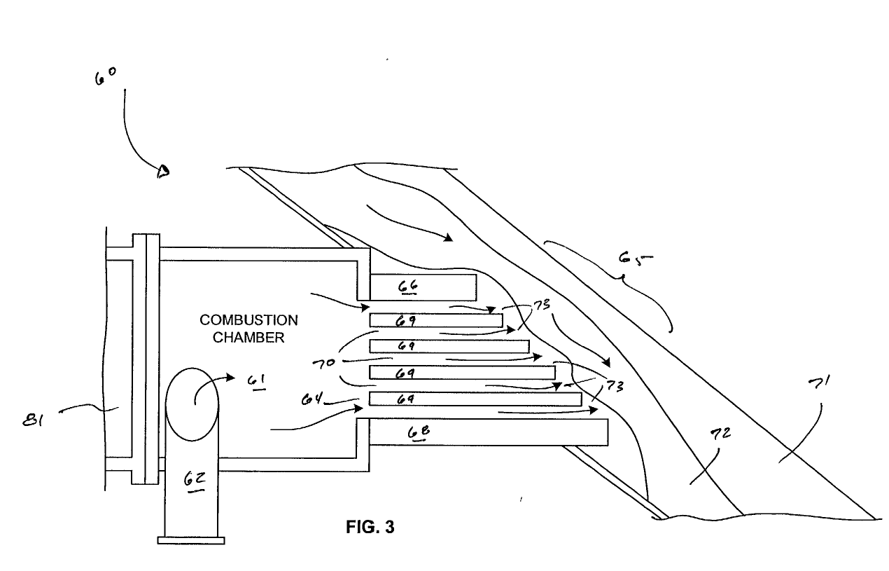

FIGS. 3 and 4 illustrate a third embodiment of the device 85 of this invention. Referring first to FIG. 3, a combustion burner 60 is illustrated having a unique burner face design intended for use in cascading a molten metal passed thereover, as will be described below. The combustion burner 60, the burner itself being any of the known types of combustion burners as described above, is provided with a combustion chamber 61. An auxiliary air or oxygen port 62 is provided as a part of the burner and is used to direct additional quantities of air or oxygen into the combustion chamber, and from thence into the gas flow or flame emitted by the combustion burner and used to cascade the molten metal as it is passed over the burner. The combustion burner has an outlet opening 64 which opens to a stair-step shaped burner face 65. The burner face is provided with a top guide 66 and a spaced bottom guide 68, which may be refractory lined and/or water cooled, as desired. A spaced series of steps 69, either refractory lined and/or water cooled, are positioned therebetween and extend between a pair of spaced side guides (not illustrated). The steps define a series of gas passageways 70 extending from the interior of the combustion chamber to the exterior of the burner face.

Referring now to both FIGS. 3 and 4, the combustion burner is situated such that its burner face extends into a transfer trough 71, for example a metal launder, or any other pipe or duct suitable for carrying molten metal therein, and through which a molten metal 72 is passed. The molten metal is passed over the burner face such that the flames or gas flow 73 emitted therefrom act to cascade the molten metal for the purposes of introducing the desired gas from the gas flow or combustion flame into the molten metal. Although not illustrated in greater detail, the combustion flames 73 emitted by the combustion burner 60 may comprise a two-part combustion flame having an inner core of a first gas, and an outer core of a second gas which jackets the inner core, in known fashion. The flame, the gas, or the gasses thereof may thus be passed into, reacted with, or otherwise dissolved within the molten metal, and used to sparge or dissolve within the molten metal. Moreover, the burner could be configured as a gas injection device, or blower, such that a gas, or gasses, but not a flame, are emitted from the device and through its stair-step shaped face for cascading the molten metal and passing the gas into the metal to sparge, mix, or react therewith, or to degasify the molten metal.

Turning now to FIG. 4, it can be seen that the device is provided with a fuel hopper 75 provided with a suitable carbon fuel such as coal or coke, which is passed through a screw conveyor 76, powered by a motor 77, and into a mixing chamber 80. The fuel received within the fuel supply hopper may also comprise a powder, to include pulverized coal, or a metal powder adapted to burn. The fuel may also comprise a saturated hydrocarbon fuel in liquid or gaseous form, such as methane, ethane, propane, butane, naphtha, or vaporized oil, and which would be separately ported or directed into the mixing chamber.

A combustion air mixture, to include oxygen and/or any other desired gases, is passed through a gas port 79 and into the mixing chamber. Thereafter the fuel, gas, and/or combustion air are mixed as desired, passed through a transfer pipe 81, and received within the combustion chamber 61 where they are combusted in known fashion, and the desired combustion flame or gas emitted from the combustion burner, through the burner face, and used to cascade and treat the molten metal, as desired. So constructed, the device 85, and in particular the combustion burner and burner face thereof can be used to cascade a molten metal thereover and introduce a gas therein.

An illustrative application of the devices 5, 35, and 85 of FIGS. 1-4, respectively, would be for the control and optimization of oxygen content in molten copper. Assuming that the first gas or inner core of the combustion flame is comprised of oxygen, the oxygen content in the molten metal may be controlled by the addition of oxygen to the combustion burner for increasing the amount of oxygen within the inner core of the burner flame, as desired. As the oxygen levels in the combustion burner, and thus the combustion flame, are capable of being precisely controlled by using a mass flow meter, for example, which measures the oxygen fed into the burner, a much greater degree of control and accuracy of the amount of oxygen added to the molten copper through the flame and cascade is attained in contrast to the known methods of oxygenating copper, to include sparging with a lance or introducing a gas into the metal bath within the vessel.

A second illustrative application of the several embodiments of the device of the invention, and of the methods practiced thereby, would be the degassing of copper for the purpose of removing dissolved hydrogen therefrom by using carbon monoxide, carbon dioxide, or nitrogen as the inner core or first gas of the gas flow/flame through which the molten metal is cascaded. The carbon monoxide and/or carbon dioxide could be produced by the combustion of coke or coal, or other carbon particles by oxygen or air in the combustion chamber of the combustion burner. Additional metals which may benefit from this type of treatment include copper alloys, and specialty coppers, to include, but not limited to, oxygen-free copper, anode copper, blister copper, phosphorus bearing copper, brasses, and bronzes, all of which require degassing or alloy addition.

The several embodiments of the invention, and methods practiced therewith as described hereinabove, may also be used for the treatment of lead to remove antimony and arsenic, or for the production of PbO and PbO₂, as well as the treatment of lead alloys of bismuth antimony, tin tellurium, and selenium. Yet another anticipated usage of the present invention would be the addition of carbon to molten streams of iron and steel using carbon monoxide, carbon dioxide, or a suspension of powdered graphite in an inert or reactive gas.

It is anticipated that the invention may also be used in the treatment of platinum and platinum group metals, which, as known, are extreme oxygen attractors, and thus need to be shielded or degassed. The present invention may also be used in the treatment of aluminum and aluminum alloys, especially to prevent dross formation or burning while pouring the metal, using argon or nitrogen, and each of which can be heated in the combustion chamber or heated externally. Other metals which may benefit from the device and methods of this invention include magnesium and other light metals such as sodium and calcium. The invention also may be used in the treatment of silicon, germanium, indium, and other semiconductor materials which require doping or minor element addition or removal during processing and formation.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the invention. Moreover, although specific terms are employed herein, they are used only in a generic and descriptive sense, and not for the purposes of limiting the described invention.

I claim:

1. A method of adding and removing gasses from a molten metal, the molten metal being formed in a metal making furnace and passed to a downstream device, said method comprising:
passing the molten metal from the furnace;
cascading the molten metal into a two part flame generated by a combustion burner, the flame being comprised of an inner core of a first gas and an outer core of a second gas jacketing the first gas; and
passing the cascaded molten metal to the downstream device.

2. The method of claim 1, further comprising the step of passing the first gas into the cascade of molten metal.

3. The method of claim 1, further comprising the step of passing the cascade of molten metal through the first gas.

4. The method of claim 1, further comprising the step of mixing the first gas with the cascade of molten metal.

5. The method of claim 1, further comprising the step of passing the cascade of molten metal into a metal bath at the downstream device.

6. The method of claim 5, the molten metal carrying the first gas into the metal bath.

7. The method of claim 5, further comprising the step of controlling the temperature of the metal bath with the flame.

8. The method of claim 1, further comprising the step of injecting the first gas into the molten metal cascade along an axis of the burner.

9. The method of claim 8, the first gas atomizing the cascade of molten metal as it is passed into the molten metal.

10. The method of claim 1, the cascade of molten metal being dispersed and carried by the flame into the downstream device.

11. The method of claim 1, further comprising the step of controlling the amount and composition of the first gas within the flame.

12. The method of claim 1, further comprising the step of cascading the molten metal into the flame from beneath the flame.

13. The method of claim 1, further comprising the step of cascading the molten metal into the flame from above the flame.

14. The method of claim 1, further comprising the step of passing the molten metal over the burner, the burner cascading the molten metal.

15. The method of claim 1, further comprising the step of passing the cascade of molten metal through a controlled combustion atmosphere.

16. A method of adding and removing gases from a molten metal, the molten metal being formed in a metal making furnace and passed to a downstream device, said method comprising:
collecting the molten metal;
cascading the molten metal into a gas flow such that a gas is passed into the molten metal; and
passing the molten metal to the downstream device.

17. The method of claim 16, the gas flow comprising an oxygenating gas flow, further comprising the step of passing oxygen into the cascade of molten metal.

18. The method of claim 17, further comprising the step of adding in the range of from zero to five hundred parts per million of oxygen to the molten metal with the gas flow.

19. The method of claim 17, further comprising the steps of generating an oxygenating gas flow with an oxy-fuel combustion burner.

20. The method of claim 19, further comprising the step of controlling the amount of oxygen supplied to the combustion burner and thereby controlling the amount of oxygen added to the molten metal by said gas flow.

21. The method of claim 16, the gas flow creating a variable oxidizing atmosphere through which the cascade of molten metal is passed.

22. The method of claim 16, further comprising the gas atomizing the molten metal as the molten metal is cascaded through the gas flow.

23. The method of claim 16, further comprising the steps of passing the molten metal through a transfer trough leading from the furnace toward the downstream device and cascading the molten metal from the transfer trough into the gas flow.

24. A method of adding a gas to a molten metal, the molten metal being formed in a metal making furnace and passed to a downstream device, said method comprising:
collecting the molten metal;
passing the molten metal over a burner emitting a gas, which gas cascades the molten metal as the metal passes over the burner; and
passing the gas into the molten metal as it cascades over the burner.

25. A method of adding a gas to a molten metal, the molten metal being formed in a metal making furnace and passed to a downstream device, said method comprising:
collecting the molten metal;
passing the molten metal over a burner emitting a two part flame comprised of an inner core of a first gas and an outer core of a second gas jacketing the first gas;
the flame cascading the molten metal as it is passed over the burner; and
passing the first gas into the molten metal as it cascades over the burner.

26. A device for adding gasses to, and removing gasses from a molten metal, the molten metal being formed in a metal making furnace, said device comprising:
a vessel adapted to receive the molten metal therein;
a transfer trough extending from the furnace toward the vessel; and
a combustion burner positioned with respect to the transfer trough and facing into the vessel, the burner being constructed and arranged to emit a flame;
wherein the transfer trough is adapted to pass the molten metal into the flame as the molten metal enters the vessel.

27. The device of claim 26, wherein the transfer trough is adapted to pass the molten metal into the flame from beneath the flame.

28. The device of claim 26, wherein the transfer trough is adapted to pass the molten metal into the flame from above the flame.

29. The device of claim 28, wherein the flame is adapted to disperse the molten metal within the vessel.

30. A device for adding gasses to, and removing gasses from a molten metal, the molten metal being formed in a metal making furnace, said device comprising:
a vessel constructed and arranged to receive the molten metal therein;
a transfer trough sized and shaped to carry the molten metal therein and extending from the furnace toward the vessel; and
a combustion burner positioned with respect to the transfer trough and facing into the vessel, the burner being constructed and arranged to emit a flame;
wherein the transfer trough is constructed and arranged to pass the molten metal off of the transfer trough as a cascade of molten metal into the flame and the vessel.

31. The device of claim 30, the flame comprising an inner core of a first gas and an outer core of a second gas jacketing the first gas, the burner and the flame being sized and shaped to pass the first gas into the molten metal as the metal cascades off of the transfer trough and into the vessel.

32. The device of claim 30, wherein the first gas is mixed with the molten metal as the molten metal cascades off of the transfer trough and through the flame.

33. The device of claim 30, said burner being constructed and arranged to create a variable oxidizing atmosphere within the vessel.

34. A device for adding gasses to, and removing gasses from a molten metal, the molten metal being formed in a metal making furnace and passed to a downstream device, said device comprising:
a transfer trough extending from the furnace toward the downstream device; and
a combustion burner positioned with respect to the transfer trough and having a stair-step shaped burner face constructed and arranged to emit a gas flow therethrough;
the transfer trough being constructed and arranged to pass the molten metal over said burner face so that the gas flow emitted therethrough cascades the molten metal passed thereover.

35. The device of claim 34, wherein the first gas is passed into and mixed with the molten metal as the molten metal cascades over said burner face.

36. The device of claim 34, said gas flow comprising a flame comprised of an inner core of a first gas and an outer core of a second gas jacketing the first gas, the first gas being passed into and mixed with the molten metal as the molten metal cascades over the stair-step burner face.

37. The device of claim 34, said transfer trough comprising a launder.

38. A method of modifying a concentration of constituents within a molten metal stream, said method comprising:
flowing a molten metal stream from a first point to a second point;
intermingling a gas stream with the molten metal stream, the gas stream comprising an inner core gas stream and a non-core gas stream, the non-core gas stream substantially enveloping the inner core gas.

39. The method of claim 38, wherein the inner core gas stream comprises a reactive gas.

40. The method of claim 39, wherein the reactive gas is selected from the group of reactive gases comprising carbon monoxide, carbon dioxide, hydrogen, oxygen, water, ozone, air, ozonated air, oxygen/air mixtures, nitrogen oxides, sulfur oxides, sulfur vapor, hydrogen cyanide, ammonia, arsine, stilbene uranium hexafluoride, selenium vapor, tellurium vapor, nickel carbonyl, naphthalene, parafin gases, alcohols, halogens, metal halogens, vaporized alloys, reactive solids suspended in inert gases, and mixtures of thereof.

41. The method of claim 38, wherein the non-core gas stream comprises primarily an inert gas.

42. The method of claim 41, wherein the inert gas is selected from the group of inert gases comprising argon, neon, helium, and nitrogen.

43. The method of claim 38, wherein the inner core gas stream comprises primarily oxidizing gases and the non-core gas stream comprises gases selected from the group comprising inert gases and primarily reducing gases.

44. The method of claim 43, wherein the inert gas is selected from the group of inert gases comprising argon, neon, helium, and nitrogen.

45. The method of claim 38, wherein the inner core gas stream comprises primarily reducing gases and the non-core gas stream comprises gases selected from the group consisting of inert gases and primarily oxidizing gases.

46. The method of claim 45, wherein the inert gas is selected from the group of inert gases comprising argon, neon, helium, and nitrogen.

47. The method of claim 38, wherein the inert gas is selected from the group of inert gases comprising argon, neon, helium, and nitrogen.

48. The method of claim 38, wherein the inner core gas stream is modulated in composition.

49. The method of claim 38, wherein the non-core gas stream is modulated in composition.

50. The method of claim 38, wherein the molten metal is selected from the group of molten metals comprising copper, brass, bronze, lead, tin, tellurium, selenium, iron , steel, platinum, aluminum, magnesium, sodium, calcium, silicon, germanium, indium, and alloys and mixtures of any two or more of thereof.

51. The method of claim 50, wherein the gas stream adjusts a concentration of an impurity in the flowing molten metal.

52. The method of claim 50, wherein the gas stream adds desirable constituents to the flowing molten metal.

53. The method of claim 38, wherein the molten metal stream comprises a molten metal cascade.

54. An apparatus for modifying a concentration of constituents within a molten metal stream, said apparatus comprising:
a burner block adapted to direct and contact a plurality of gas streams within a flowing molten metal stream, the burner block comprising a cold end and a hot end adapted to contact the molten metal;
a plurality of hollow channels extending from the cold end to the hot end of said burner block, and from which emanate the plurality of gas streams;
each said channel being formed from a plurality of walls that spatially divide the respective channels, each said wall having a hot end adapted to contact the molten metal.

55. The apparatus of claim 54, wherein each of the plurality of walls are varied in length.

56. The apparatus of claim 55, wherein each of the plurality of walls has a length, the length of each wall N being shorter than a length of a wall N+1 in the order which the wall ends contact the molten metal.

57. The apparatus of claim 56, said apparatus being connected to a launder such that the molten metal flows therethrough.

58. The apparatus of claim 54, wherein the walls are comprised of materials adapted to deliver a gas selected from the group of gases comprising carbon monoxide, carbon dioxide, hydrogen, oxygen, water, ozone, air, ozonated air, oxygen/air mixtures, nitrogen oxides, sulfur oxides, sulfur vapor, hydrogen cyanide, ammonia, arsine, stilbene uranium hexafluoride, selenium vapor, tellurium vapor, nickel carbonyl, naphthalene, parrafin gases, alcohols, halogens, metal halogens, vaporized alloys, reactive solids suspended in inert gases, and mixtures of thereof.

59. The apparatus of claim 54, said apparatus being connected to a launder such that the molten metal flows therethrough.
